(19) United States
(12) Patent Application Publication
(10) Pub. No.: US 2003/0039121 A1
(43) Pub. Date: Feb. 27, 2003

(54) Working lamp

(76) Inventor: Fumiyoshi Nezigane, Shizuoka-shi (JP)

Correspondence Address: John S. Egbert, Harrison & Egbert, 7th Floor, 412 Main Street, Houston, TX, 77002, US

(21) Appl. No.: 10/121,770

(22) Filed: Apr. 12, 2002

(30) Foreign Application Priority Data
Aug. 24, 2001 (JP) 2001-005592

(51) Int. Cl. F21V 7/00

(52) U.S. Cl. 362/247; 362/240; 362/186

(57) ABSTRACT

A working lamp comprising a transparent or translucent hollow cylindrical body having a handle. The cylindrical body is provided in the direction of the length thereof with a reflecting means. The cylindrical body is internally provided with a large number of light emitting diodes. The cylindrical body is provided on an outer surface thereof near the reflecting means with a permanent magnet. Since the working lamp of the present invention comprises a large number of light emitting diodes disposed within the transparent or translucent hollow cylindrical body, the working lamp can be made small in size to such an extent that the working lamp is capable of being carried or put in a pocket. Therefore, the working lamp of the invention is suited for lightening things disposed in complicated or narrow places. Since the light emitting diodes lighten a wide area, things are made very easy to see.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a working lamp. More particularly, the invention relates to a working lamp for lightening things disposed in complicated or narrow places, for example, within an engine compartment or at the back of instruments of an automotive vehicle.

### BACKGROUND OF THE INVENTION

Conventional working lamps comprise a transparent or translucent hollow cylindrical body having a handle, said cylindrical body being provided in the direction of the length thereof with a reflecting means, said cylindrical body being internally provided with a fluorescent light.

The conventional working lamps are large in size because the cylindrical body thereof is internally provided with a fluorescent light. For example, typical working lamps have an overall length of about 40 cm and the cylindrical body thereof has a diameter of about 5 cm. Thus, the conventional working lamps are too large to be used for lightening things disposed in complicated or narrow places, for example, within an engine compartment or at the back of instruments of an automotive vehicle.

### BRIEF SUMMARY OF THE INVENTION

It is therefore an object of the invention to provide a working lamp, which has obviated the above-mentioned disadvantage of the prior art.

It is another object of the invention to provide a working lamp, which can be favorably used in complicated or narrow places.

These and other objects have been attained by a working lamp comprising a large number of light emitting diodes. The working lamp of the present invention comprises a transparent or translucent hollow cylindrical body having a handle, said cylindrical body being provided in the direction of the length thereof with a reflecting means, said cylindrical body being internally provided with a large number of light emitting diodes, said cylindrical body being provided on an outer surface thereof near said reflecting means with a permanent magnet.

The working lamp of the present invention lightens things by means of the light emitting diodes disposed within the transparent or translucent hollow cylindrical body either with the handle in hand or with the working lamp fixed near said things by means of the permanent magnet. Light emitted by the diodes passes through the cylindrical body either directly or after being reflected by the reflecting means, and reaches said things.

Since the working lamp of the present invention comprises a large number of light emitting diodes, which are very small in size, disposed within the transparent or translucent hollow cylindrical body, the working lamp can be made small in size to such an extent that the working lamp is capable of being carried or put in a pocket. Said large number of light emitting diodes lighten a wide area.

### BRIEF DESCRIPTION OF THE SEVERAL VIEWS OF THE DRAWINGS

FIG. 1 is a perspective view showing an example of a working lamp according to the present invention.

FIG. 2 is a sectional view of said working lamp.

### DETAILED DESCRIPTION OF THE INVENTION

The present invention will now be described in detail with reference to the attached drawings.

Reference symbol 1 represents a transparent or translucent hollow cylindrical body. The cylindrical body 1 is formed of a glass, synthetic resin, etc. A handle 3 is attached to an end of the cylindrical body 1. A battery 5 is disposed within the handle 3. The cylindrical body 1 is provided in the direction of the length thereof with a reflecting means 7. The reflecting means 7 may be a reflecting film disposed on an inner or outer surface of the cylindrical body 1.

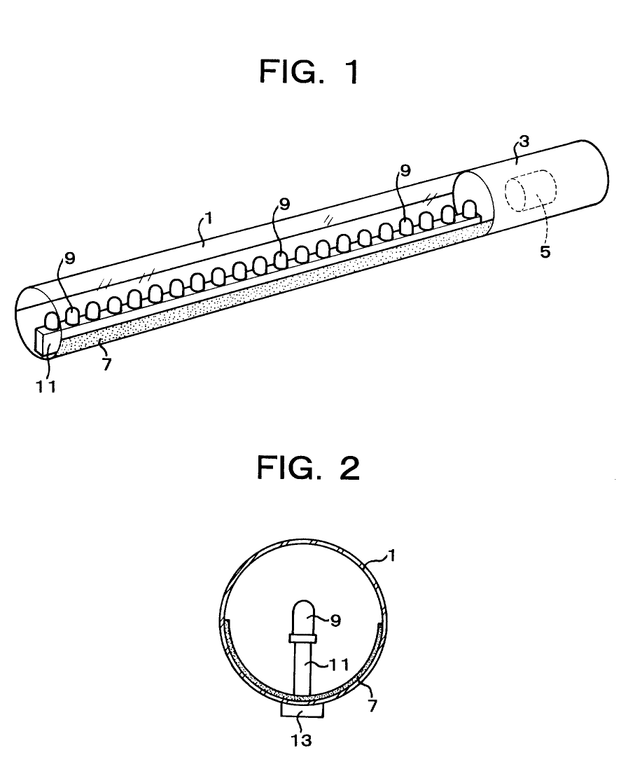

A large number of light emitting diodes 9 are disposed within the cylindrical body 1. Each of the light emitting diodes 9 is electrically connected to the battery 5. In an embodiment shown in FIGS. 1 and 2, a large number of light emitting diodes 9 are mounted on a supporting member 11 fixed within the cylindrical body 1.

The cylindrical body 1 is provided on an outer surface thereof near the reflecting means 7 with a single permanent magnet 13 or a plurality of permanent magnets 13.

The present invention has the following advantages.

Since the working lamp of the present invention comprises a large number of light emitting diodes, which are very small in size, disposed within the transparent or translucent hollow cylindrical body, the working lamp can be made small in size to such an extent that the working lamp is capable of being carried or put in a pocket. Therefore, the working lamp of the invention is suited for lightening things disposed in complicated or narrow places, for example, within an engine compartment or at the back of instruments of an automotive vehicle. Since said large number of light emitting diodes lighten a wide area, things are made very easy to see.

Since the working lamp of the present invention can be fixed near said things by means of the permanent magnet, the user of the working lamp can use both hands while at work.

As many apparently widely different embodiments of the present invention may be made without departing from the spirit and scope thereof, it is to be understood that the invention is not limited to the specific embodiments thereof except as defined in the appended claim.

I claim:

1. A working lamp comprising a transparent or translucent hollow cylindrical body having a handle, said cylindrical body being provided in the direction of the length thereof with a reflecting means, said cylindrical body being internally provided with a large number of light emitting diodes, said cylindrical body being provided on an outer surface thereof near said reflecting means with a permanent magnet.
